(19) United States
(12) Patent Application Publication
(10) Pub. No.: US 2025/0313057 A1
(43) Pub. Date: Oct. 9, 2025

(54) AIR CONDITIONING UNIT FOR A MOTOR VEHICLE AND CLIMATE CONTROL SYSTEM WITH THE AIR CONDITIONING UNIT AND METHOD FOR OPERATING THE AIR CONDITIONING UNIT

(71) Applicant: Hanon Systems, Daejeon (KR)

(72) Inventors: Thomas Ehlers, Krefeld (DE); Peter Klotten, Köln (DE); Martin Paul Nowak, Rösrath (DE)

(21) Appl. No.: 18/869,583

(22) PCT Filed: Jun. 15, 2023
(86) PCT No.: PCT/KR2023/008229

§ 371 Date: Nov. 26, 2024

(30) Foreign Application Priority Data
Jul. 15, 2022 (DE) 102022117714.9
May 26, 2023 (DE) 102023113881.2

(51) Int. Cl. B60H 1/00

(52) U.S. Cl. CPC B60H 1/00021; B60H 2001/00085; B60H 2001/00092

(57) ABSTRACT

Air conditioning unit for a motor vehicle and climate control system with the air conditioning unit having a casing with at least one first air inlet for the intake of fresh ambient air and one second air inlet for the intake of circulating air from a passenger compartment, as well as an air guiding device in each case for independently varying flow cross sections of the air inlets, the air guiding device in each case is designed as an air flap which is arranged movably mounted between two end positions, a bypass flow duct with a ram pressure air guiding device is formed for the first air inlet, and the ram pressure air guiding device is arranged as an air flap movably mounted between two end positions and is designed in such a way as to fully close the bypass flow duct in an end position.

### CROSS REFERENCE TO RELATED PATENT APPLICATIONS

This is a U.S. national phase patent application of PCT/KR2023/008229 filed Jun. 15, 2023, which claims the benefit of and priority to German Patent Application No. 10 2023 113 881.2 filed on May 26, 2023 and German Patent Application No. 10 2022 117 714.9 filed on Jul. 15, 2022, the entire contents of each of which are incorporated herein by reference for all purposes.

### TECHNICAL FIELD

The invention relates to an air conditioning unit for a motor vehicle. The air conditioning unit has a casing with at least one first air inlet for the intake of fresh ambient air, one second air inlet for the intake of circulating air from a passenger compartment and an air guiding device in each case for independently varying flow cross sections of the air inlets. In each case the air guiding device is designed as an air flap which is movably mounted between two end positions.

The invention also relates to a climate control system for a motor vehicle with means for conveying, for cooling and for heating air, as well as the air conditioning unit, and a method for operating the air conditioning unit.

### BACKGROUND ART

In motor vehicles, due to the increasing number of technical components and the increasing demands on comfort, it is not only necessary to optimize the structural volume, but also the functionality of the components. The effectiveness of the components of the air conditioning unit must be increased.

Generic air conditioning units have an air inlet casing with an air inlet for the outside air drawn in from outside the passenger compartment of the vehicle, also referred to as fresh air or ambient air, as well as an air inlet for the circulating air taken from the passenger compartment. The air is taken in by a fan into the air conditioning unit via the inlets, then conditioned and fed into the passenger compartment through suitable distribution openings, also known as air outlets.

The position of at least one flap arranged within the air inlet casing determines whether the intake air mass flow is made up of pure fresh air, pure circulating air or a mixture of fresh air and circulating air. In this case, the flap is mounted to be adjustable within the casing between two end positions, in particular pivotably in most cases. Mixing the intake air mass flow is achieved by an intermediate position of the flap between the two end positions.

DE 199 15 966 A1 discloses an air inlet casing for a heating and/or air conditioning system of a motor vehicle. The air inlet casing comprises an outside air inlet, a circulating air inlet, an outlet connected to a fan, and a flap. The flap is mounted pivotably within the casing between an outside air position and a circulating air position and can assume intermediate positions.

In air inlet casings known from the prior art, undesired bypass flows occur, for example, when the flap is in intermediate positions between the inlet for the fresh air and the inlet for the circulating air, with fresh air flowing past the flap and being introduced into the passenger compartment of the vehicle through the inlet for the circulating air without being conditioned. As a result of such a bypass mass flow, for example, outside air that is too cold or too warm can get directly into the passenger compartment.

The cause of the bypass flows is running the motor vehicle at high speed. In this case, at the inlet for the fresh air, there is a high ram pressure of the air, which must be compensated, on the one hand, to keep the amount of air conveyed by the fan constant and, on the other hand, to avoid outside air from flowing directly into the inlet for the circulating air, and thus into the passenger compartment. The flow cross section for the supply of fresh air must be greatly reduced, particularly in the case of small amounts of fresh air and high ram pressures. The condition described occurs more and more frequently, especially in connection with motor vehicles driven by electric motors, since the climate control system is operated with less fresh air and more circulating air due to the electrical energy savings and thus with the possible range of the vehicle in mind. Consequently, the consideration of the ram pressure regulation in the air conditioning unit is gaining in importance.

In the case of ram pressure compensation or ram pressure regulation, the flow cross section of the air intake is reduced as a function of the vehicle speed. Ram pressure compensation is therefore to be understood as a throttling of the high pre-pressure generated by a high vehicle speed in the inlet area of the air inlet casing.

Since, on the one hand, the inlet for the fresh air also has a large flow cross section, in particular in order to generate the lowest possible air resistance at operating points of the climate control system with large quantities of fresh air, it is also a great challenge to close the inlet for the fresh air with a single flap so as to ensure sufficient ram pressure regulation when only small amounts of fresh air are needed.

It is known from the prior art to implement the ram pressure regulation directly via a flap that varies the flow cross section of the inlet for the fresh air, also referred to as fresh air flap, by said flap constantly closing the flow cross section of the inlet for the fresh air as the ram pressure increases. The ram pressure-dependent closing of the inlet for the fresh air leads to very narrow, gap-shaped flow cross sections of the inlet for the fresh air formed between the fresh air flap and the casing of the air conditioning unit at high ram pressures and low conveyed quantities of fresh air. With very small flow cross sections of the inlet for the fresh air, the necessary ram pressure regulation is very difficult or impossible both technically, because the movement of the flap is not controlled with a conventional stepper motor without play, and physically. In addition, flow cross sections that are too small, promote a disturbing noise generation, such as hissing or whistling.

In order to throttle the high ram pressure in the air inlet duct upstream of the fresh air flap at high vehicle speeds, upstream ram pressure flaps are also conventionally used in the area of the air intake, since it is not sufficient, for example, to adjust the speed of the fan to the vehicle speed to regulate the ram pressure of the outside air that is a function of the driving speed.

In the case of known air inlet casings with a single flap, which enables the positions “fresh air” and “circulating air” or “partial circulating air” as intermediate positions, an additional second flap is consequently required for ram pressure compensation. This applies in particular if a portion of the air is taken in from the passenger compartment in the position “partial circulating air”. However, the upstream ram pressure flap used for ram pressure compensation requires a corresponding installation space in the air inlet of the air conditioning unit.

DE 10 2004 004 165 B3 discloses an air inlet for a ventilation, heating or air conditioning system of a motor vehicle with an outside air duct supplying outside air, a circulating air duct supplying circulating air, a ram air flap for controlling the outside air duct, as well as a circulating air flap for controlling the circulating air duct. The circulating air flap and the ram air flap are designed as a combined ventilation flap which, when the circulating air duct is closed, enables the air mass flow flowing through the outside air duct to be throttled.

With increasing demands on efficient operation of the climate control system as well as on the comfort to be provided, the air quantities or air mass flows to be controlled become smaller and are within narrow, predefined ranges. In this case, small amounts of air cannot be set with sufficient accuracy with control flaps closing a larger flow cross section, since, for example, small opening angles of a rotatably mounted control flap already release a larger flow cross section than is required to let through the desired air mass flow. Sensitive regulation of the air mass flow becomes even more difficult as the ram pressure increases.

The systems known in the prior art also have in common that they have additional elements that are very complex in terms of setup, which also take up more space and require a control system, entailing higher costs and also additional assembly work and corresponding maintenance work.

In addition, the flap geometries known from the prior art cause loud flow noise.

### SUMMARY

The object of the present invention is to provide an air inlet of an air conditioning unit for a motor vehicle, which enables both the functions of letting in fresh air and circulating air as well as partial circulating air as a mixture of fresh air and circulating air. When letting in partial circulating air, continuous ram pressure compensation, dependent on the driving speed, must be provided to ensure comfort in the passenger compartment. Bypass flows from the fresh air inlet to the circulating air inlet are to be prevented. Even with high ram pressures and small amounts of fresh air, the air intake should function robustly, reproducibly and acoustically neutrally and be optimally controllable. With a targeted air routing, the installation space requirement and the costs incurred, for example for control, manufacture, assembly and maintenance, should be minimized.

The object is achieved by the subject matter with the features shown and described herein.

The object is achieved by an air conditioning unit according to the invention for a motor vehicle. The air conditioning unit has a casing with at least one first air inlet for the intake of fresh air from the area surrounding the motor vehicle and one second air inlet for the intake of circulating air from a passenger compartment, as well as an air guiding device in each case for independently varying flow cross sections of the air inlets. The air guiding device in each case is designed as an air flap which is movably mounted between two end positions.

According to the basic idea of the invention, a bypass flow duct with a ram pressure air guiding device for compensating ram pressure is provided for the first air inlet for the intake of fresh ambient air. In this case, the ram pressure air guiding device is arranged as an air flap movably mounted between two end positions and is designed in such a way as to fully close the bypass flow duct in an end position. The ram pressure air guiding device is advantageously arranged within the bypass flow duct.

The bypass flow duct preferably extends parallel to the air inlet of the fresh ambient air, in particular to a closing cross-sectional area of the air inlet. In this case, the bypass flow duct branches off in the flow direction of the fresh air before the cross-sectional area of the air inlet to be closed and opens into the air inlet after the cross-sectional area of the air inlet to be closed, so that fresh air guided through the bypass flow duct can be routed around the closable cross-sectional area of the air inlet.

The ram pressure air guiding device is used in conjunction with the air guiding device of the first air inlet to compensate for the ram pressure within the first air inlet for the intake of fresh air. In this way, the overpressure in the first air inlet is fully reduced compared to the second air inlet for the intake of circulating air from the passenger compartment, so that a direct passage of air as an air mass flow of fresh air flowing in through the first air inlet through the second air inlet into the passenger compartment is prevented. The compensation of the ram pressure is ensured by corresponding positions of the ram pressure air guiding device and the first air guiding device in different speed ranges of the motor vehicle with different degrees of throttling the fresh air.

According to a refinement of the invention, the bypass flow duct has a smaller flow cross section than the first air inlet.

Advantageously, the ram pressure air guiding device is movable independently of the first air guiding device in order to vary the flow cross section of the first air inlet and is therefore used to vary only a portion of a flow cross section of the fresh ambient air, which is composed of the flow cross section of the first air inlet and the flow cross section of the bypass flow duct.

According to a preferred configuration of the invention, the air guiding devices of the first air inlet and/or of the second air inlet and/or the ram pressure air guiding device for varying the flow cross section of the bypass flow duct is/are arranged pivotably mounted about an axis of rotation in each case. Alternatively, the air flaps can also be designed to be displaceable, for example.

The ram pressure air guiding device is pivotable in particular in such a way that in the individual positions of the ram pressure air guiding device with partial circulating air, that is to say, between the end positions, there is a vehicle-specifically adapted throttling of the air mass flow of fresh air flowing through the bypass flow duct into the air conditioning unit, depending on the pressure in front of the bypass flow duct or the first air inlet. A gap that occurs between the casing and the ram pressure air guiding device during a rotational movement of the ram pressure air guiding device is adjusted in the free flow cross section depending on the required throttling of the fresh air.

In order to compensate for the ram pressure by means of corresponding positions of the ram pressure air guiding device and the first air guiding device in different speed ranges of the motor vehicle with different degrees of throttling of the fresh air, combinations of the respective positioning of the first air guiding device and the ram pressure air guiding device and thus varying the flow cross sections of the first air inlet and the bypass flow duct as total flow cross section of the fresh air are possible.

The ram pressure air guiding device for varying the flow cross section of the bypass flow duct and/or the first air guiding device for varying the flow cross section of the first air inlet can each be designed as a centrally mounted rotary flap which is pivotally mounted about the axis of rotation between a first end position “closed” and a second end position “fully open”. In this case the axis of rotation can be arranged in each case in the area of the cross-sectional area of the air inlet to be closed.

The casing of the air conditioning unit preferably has a fan casing for accommodating a fan and an air inlet casing with the air inlets. The fan casing is arranged downstream of the air inlet casing in the flow direction of the air mass flow taken in by the air conditioning unit.

A further advantage of the invention is that the ram pressure air guiding device is continuously alignable on a travel path between the two end positions in intermediate positions for opening the flow cross section of the bypass flow duct with different degrees of opening, wherein the ram pressure air guiding device in the first end position “closed” abuts the casing, in particular at the air inlet casing of the casing and seals the bypass flow duct.

According to a refinement of the invention, the air guiding device for varying the flow cross section of the second air inlet is designed as a rotary flap which is pivotably mounted about the axis of rotation between a first end position “closed” and a second end position “fully open”. In contrast to a centrally mounted rotary flap, the axis of rotation is arranged in this case at a distance from the cross-sectional area of the air inlet to be closed.

The respective air guiding device of the first air inlet for the intake of fresh ambient air and of the second air inlet for the intake of circulating air from the passenger compartment can be continuously alignable on a travel path between the two end positions in intermediate positions for opening the corresponding flow cross section of the air inlet with different degrees of opening. In the first end position “closed”, the air guiding device abuts in each case the air inlet casing and seals the air inlet.

A further advantageous configuration of the invention consists in the fact that seals are provided on the end faces of the surfaces of the air guiding devices of the air inlets or the ram pressure air guiding device. The seals, which each extend fully along the end faces and are firmly connected to the air guiding device or the ram pressure air guiding device, are designed in connection with the air guiding device or the ram pressure air guiding device to close the respective air inlet or the bypass flow duct, depending on the position of the air guiding device or the ram pressure air guiding device in one of the end positions.

According to a preferred configuration of the invention, the first air guiding device and the ram pressure air guiding device are each connected to a drive element or to a common drive element via a drive mechanism, which drives both the first air guiding device and the ram pressure air guiding device, so that only one drive element is provided for actuating both air guiding devices.

The drive element is advantageously designed in each case as a stepper motor. Alternatively, the drive element can also be designed as a direct current motor.

The object of the invention is also achieved by a climate control system according to the invention for a motor vehicle with means for conveying, for cooling and for heating air and the air conditioning unit according to the basic idea.

Furthermore, the object of the invention is achieved by a method according to the invention for operating the air conditioning unit according to the basic idea for a motor vehicle.

In this case, a composition of the air mass flow consisting of pure fresh ambient air, pure circulating air from the passenger compartment or a mixture of fresh air and circulating air taken in by the air conditioning unit is set by adjusting positions of air guiding devices as well as the ram pressure air guiding device for independently varying flow cross sections of air inlets and the bypass flow duct. When operating the air conditioning unit in an operating mode of ram pressure compensation, a mass flow of the fresh air is throttled through the flow cross section of the bypass flow duct, in that the air guiding device arranged in the flow cross section of an air inlet of the fresh air is brought into the end position “closed” and the ram pressure air guiding device arranged in the bypass flow duct independently of the air guiding device of the air inlet of the fresh air is adjusted about the axis of rotation in such a way that an open gap is formed between a wall of the casing of the air conditioning unit and the ram pressure air guiding device and the flow cross section of the air inlet of the fresh air is opened depending on the alignment of the ram pressure air guiding device.

In order to maintain a constant air throughput of fresh air, it is advantageous that the ram pressure air guiding device in connection with the first air guiding device and thus the air conditioning unit is increasingly closed with increasing speed of the motor vehicle, which, by different positions of the ram pressure air guiding device in combination with the first air guiding device, ensures a throttling of the fresh air that is adapted to the speeds of the motor vehicle for different speed ranges of the motor vehicle.

The air conditioning unit according to the invention can advantageously be operated with particularly small amounts of air at critical operating points, at which precise regulation of the proportion of fresh air is required. In this case, the proportion of fresh air to be regulated is correspondingly reduced by the bypass flow duct and can be set precisely with the ram pressure air guiding device closing the flow cross section of the bypass flow duct, which is smaller than that for the intake of fresh air, since with a small twisting angle of the ram pressure air guiding device only a small flow cross section is released for the fresh air and thus the desired accuracy of the regulation of the amount of fresh air is achieved.

With the formation of the bypass flow duct for the air inlet of the fresh air with the ram pressure air guiding device, the desired small flow cross section of the fresh air can be set precisely by closing the large flow cross section of the air inlet of the fresh air and opening the smaller flow cross section of the bypass flow duct for the fresh air. The ram pressure air guiding device arranged in the bypass flow duct with a smaller width than the air guiding device of the air inlet of the fresh air enables in this case a more precise gap control than a change in the flow cross section of the fresh air per rotation angle of the corresponding air guiding device. Consequently, the smaller opening cross section and opening angle of the ram pressure air guiding device compared to the air guiding device of the air inlet of the fresh air enables a more precise control of the flow cross section with a gap-shaped opening. The corresponding difference is clearly apparent in the speed compensation modes with throttling a high ram pressure of the fresh air. This approach ensures ram pressure compensation when operating with an open air guiding device for the circulating air, in particular when operating with partial circulating air, and when operating exclusively with fresh air.

In each case, a large quantity of fresh air is reduced to a smaller quantity of fresh air as it flows through the bypass flow duct, so that the required quantity of air can be set in a robust manner with practicable twisting angles of the ram pressure air guiding device. The amount of fresh air to be regulated by the ram pressure induced by the speed of the motor vehicle is constructively reduced even before the ram pressure air guiding device.

In summary, the air conditioning unit according to the invention has various other advantages:
a driving speed-dependent, continuous compensation of the ram pressure, thereby preventing the overflow of fresh air into the air inlet for the intake of circulating air and thus into the passenger compartment,
optimal and reliable controllability even with high ram pressures and small amounts of incoming fresh air with minimal susceptibility to failure,
minimal energy consumption for climate control, specifically for heating and cooling the air for the passenger compartment, as a result
minimum required battery capacity, especially in electrically powered motor vehicles, and minimum consumption of resources and maximum range, also through minimal weight, as well as
minimal installation space with minimal use of materials and minimal effort for manufacture, assembly and maintenance of the air conditioning unit.

### DESCRIPTION OF DRAWINGS

Further details, features and advantages of the invention are apparent from the following description of exemplary embodiments with reference to the accompanying drawings, in which:

FIG. 1A: shows a sectional view of a first air conditioning unit of a motor vehicle with a fan casing with a fan and an air inlet casing with two air inlets and an air guiding device for varying the flow cross sections of the air inlets from the prior art,

FIG. 1B: shows a sectional view of a second air conditioning unit of a motor vehicle with the fan casing with the fan and the air inlet casing with two air inlets and one air guiding device each for independently varying the flow cross sections of the air inlets from the prior art,

FIGS. 2A and 2B: show a third air conditioning unit from the prior art in comparison with an air conditioning unit according to the invention for a motor vehicle, each with the air inlet casing with two air inlets and each with an air guiding device for independently varying the flow cross sections of the air inlets, each in a sectional view, with a first air inlet being fully open and a second air inlet being closed,

FIGS. 2C and 2D: show a sectional view of the third air conditioning unit from the prior art in comparison with the air conditioning unit according to the invention from FIGS. 2A and 2B, each with the first closed air inlet and the second fully open air inlet,

FIGS. 3A and 3B: show each a detailed view of the first air guiding device within the air inlet casing of the third air conditioning unit from FIG. 2A in an intermediate position for ram pressure compensation,

FIG. 4A to 4C: show each a perspective view of the air conditioning unit according to the invention with the air inlet casing with two air inlets and the bypass flow duct to the first air inlet as well as an air guiding device for varying the flow cross sections of the air inlets and the bypass flow duct in each case,

FIG. 5A: shows a sectional view of the air conditioning unit according to the invention from FIG. 4A with the first air inlet being closed and the bypass flow duct for ram pressure compensation as well as the second air inlet being fully open in each case, and

FIG. 5B: shows a detailed representation of the bypass flow duct of the air conditioning unit according to the invention from FIG. 4A with the first air inlet being closed and the bypass flow duct for ram pressure compensation being partially open, as well as

FIG. 5C: shows a sectional view of the air conditioning unit according to the invention from FIG. 4A, with the first air inlet being closed and the bypass flow duct for ram pressure compensation being fully open, as well as the second air inlet being closed.

### DESCRIPTION OF AN EMBODIMENT

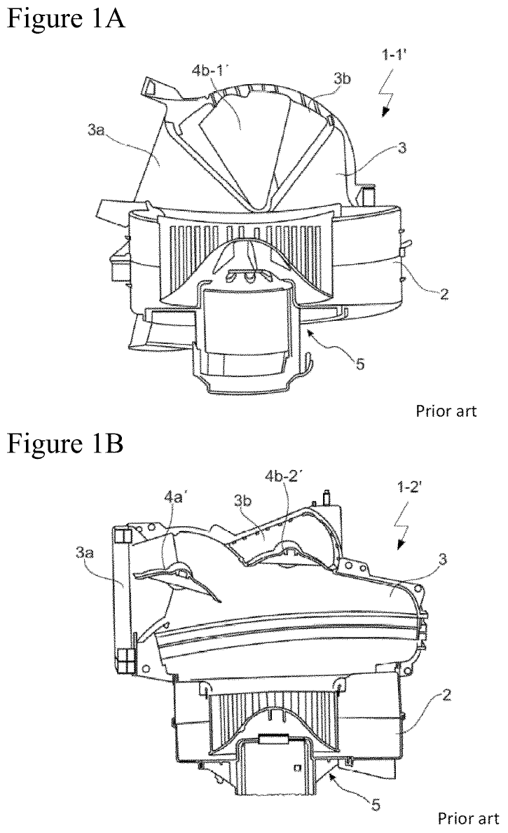

FIG. 1A shows a sectional view of a first air conditioning unit 1-1′ of a motor vehicle with a fan casing 2 with a fan 5 and an air inlet casing 3 with two air inlets 3a, 3b and an air guiding device 4b-1′ for varying the flow cross sections of the air inlets 3a, 3b from the prior art.

The individual air guiding device 4b-1′, mounted as an air flap pivotable about an axis of rotation, serves to simultaneously vary the flow cross sections of a first air inlet 3a for the inflow of fresh ambient air as well as a second air inlet 3b for the inflow of circulating air from the passenger compartment. The first air inlet 3a is consequently designed as a fresh air inlet, while the second air inlet 3b is designed as a circulating air inlet. The air inlets 3a, 3b are opened or closed interdependently.

The fan 5 has a drive component, in particular an electric motor, and an impeller. The air taken in by fan 5 into fan casing 2 through the air inlet casing 3 is conditioned and introduced into the passenger compartment through air outlets (not shown). The composition of the intake air mass flow of pure fresh air, pure circulating air or a mixture of fresh air and circulating air is varied by means of the position of the air guiding device 4b-1′. The air guiding device 4b-1′ is pivotable about the axis of rotation between two end positions. The axis of rotation is formed at a distance from the cross-sectional area of the air inlets 3a, 3b to be closed and thus outside the cross-sectional area to be closed.

The mixture of the intake air mass flow is set in each case via an intermediate position of the air guiding device 4b-1′ between the two end positions.

In intermediate positions of the air guiding device 4b-1′, bypass flows can occur in which fresh air flowing through the first air inlet 3a into the air inlet casing 3 flows around the air guiding device 4b-1′, and the fresh air unintentionally flows through the second air inlet 3b for the circulating air into the passenger compartment of the vehicle, so that outside air that is either too cold or too warm enters the passenger compartment directly.

The first air conditioning device 1-1′ designed in this way does not allow for ram pressure regulation. The flow cross section of the first air inlet 3a cannot be controlled for throttling the fresh air flowing in through the first air inlet 3a, so that in certain operating modes of the air conditioning unit 1-1′ the fresh air is unintentionally guided into the passenger compartment without conditioning through the second air inlet 3b.

FIG. 1B shows a sectional view of a second air conditioning unit 1-2′ of a motor vehicle with the fan casing 2 with the fan 5 as well as the air inlet casing 3 with the two air inlets 3a, 3b and one air guiding device 4a′, 4b-2′ in each case for independently varying the flow cross sections of the air inlets 3a, 3b from the prior art.

The air guiding devices 4a′, 4b-2′, which are each mounted as an air flap pivotable about an axis of rotation, are designed as centrally mounted rotary flaps and can in turn each be pivoted about an axis of rotation between two end positions. Here, the axis of rotation is in each case arranged in the region of the cross-sectional area of the air inlets 3a, 3b to be closed and thus within the cross-sectional area to be closed.

The air guiding devices 4a′, 4b-2′ are used to independently vary the flow cross sections of the first air inlet 3a for the inflow of fresh ambient air, as well as of the second air inlet 3b for the inflow of circulating air from the passenger compartment.

The air guiding devices 4a′, 4b-2′ each have different intermediate positions on the travel path from a first end position “closed” to a second end position “fully open”, which enable different degrees of opening of the air inlets 3a, 3b. In the first end position “closed”, the air guiding devices 4a′, 4b-2′ each sealingly abut the air inlet casing 3. In the representation from FIG. 1B, the first air inlet 3a is “fully open”, while the second air inlet 3b is “closed”.

The design of the air guiding devices 4a′, 4b-2′, which can be pivoted independently of one another, also allows independent control of fresh air and circulating air into the air inlet casing 3 with ram pressure control at the first air inlet 3a if the first air guiding device 4a′ is moved towards the end position “closed”, but has not reached it yet. However, flow cross sections of the first air inlet 3a that are only slightly open are difficult to control for ram pressure compensation, since a minimal rotation of the first air guiding device 4a′ causes a large change in the flow cross section.

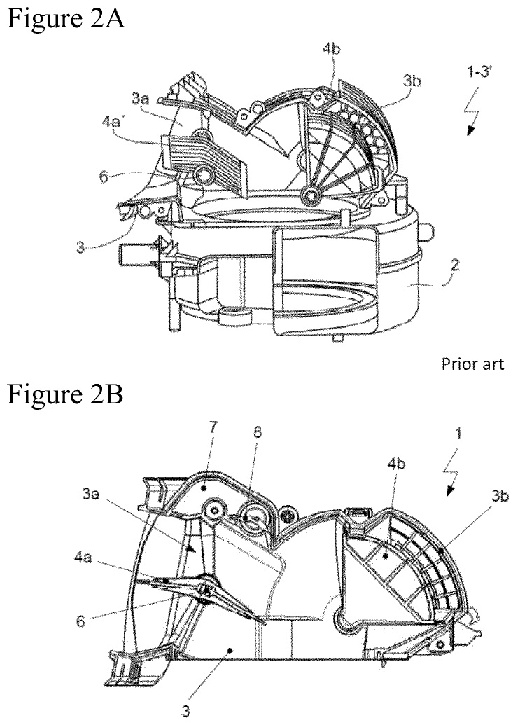

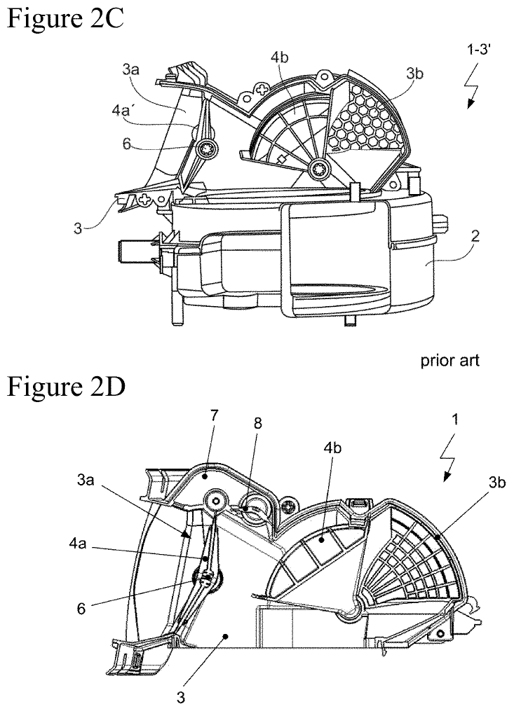

FIGS. 2A and 2B as well as 2C and 2D each show a sectional view of a third air conditioning unit 1-3′ from the prior art in comparison with an air conditioning unit 1 according to the invention of a motor vehicle, each with the air inlet casing 3 with two air inlets 3a, 3b and one air guiding device 4a′, 4a, 4b each for independently varying the flow cross sections of the air inlets 3a, 3b for the inflow of fresh ambient air as well as of circulating air from the passenger compartment.

The air conditioning unit 1 according to the invention has a bypass flow duct 7 with an air guiding device, in particular a ram pressure air guiding device 8, for opening and closing the bypass flow duct 7. In this case, the bypass flow duct 7 extends parallel to the air inlet 3a for the inflow of fresh ambient air, in particular parallel to the cross-sectional area of the air inlet 3a to be closed. Here, the bypass flow duct 7 branches off upstream of the cross-sectional area of the air inlet 3a to be closed and opens into the air inlet 3a downstream of the cross-sectional area of the air inlet 3a to be closed.

According to FIGS. 2A and 2B, the first air inlet 3a is fully open for the inflow of fresh air and the second air inlet 3b is closed for the inflow of circulating air, so that only fresh air is taken in through the first air inlet 3a. The ram pressure air guiding device 8 and thus the bypass flow duct 7 of the air conditioning unit 1 are closed according to FIG. 2B. According to FIGS. 2C and 2D, the first air inlet 3a is closed for the inflow of fresh air and the second air inlet 3b is fully open for the inflow of circulating air. The ram pressure air guiding device 8 and thus the bypass flow duct 7 of the air conditioning unit 1 are also closed according to FIG. 2D, so that only circulating air flows into the air inlet casing 3 through the second air inlet 3b.

The first air guiding devices 4a′, 4a are each mounted as an air flap or centrally mounted rotary flap so as to be pivotable about an axis of rotation 6 between two end positions. The axis of rotation 6 is arranged in the region of the cross-sectional area of the first air inlet 3a to be closed. The second air guiding devices 4b are also each designed as an air flap that is pivotable about an axis of rotation between two end positions, which, compared to the axis of rotation 6 of the first air guiding device 4a′, 4a, are arranged at a distance from the cross-sectional area of the air inlets 3b to be closed.

In the third air conditioning unit 1-3′ from the prior art, ram pressure control takes place directly via the first air guiding device 4a′, which varies the flow cross section of the first air inlet 3a. In this case, the first air guiding device 4a′ is moved continuously closing the flow cross section of the first air inlet 3a as the ram pressure increases.

The ram pressure air guiding device 8 of the bypass flow duct 7 is used to vary the flow cross section of the bypass flow duct 7 for the inflow of fresh ambient air into the air conditioning unit 1 independently of the position of the air guiding device 4a of the first air inlet 3a and has different intermediate positions on the travel path from a first end position “closed” to a second end position “fully open”, which enable different degrees of opening of the bypass flow duct 7. In the first end position “closed”, the ram pressure air guiding device 8 abuts sealingly the air inlet casing 3.

In particular, at speeds of the motor vehicle which cause only a low ram pressure of the fresh air, the ram pressure air guiding device 8 is closed, so that the air volume of the fresh air flowing into the air conditioning unit 1 is adjusted by means of the first air guiding device 4a.

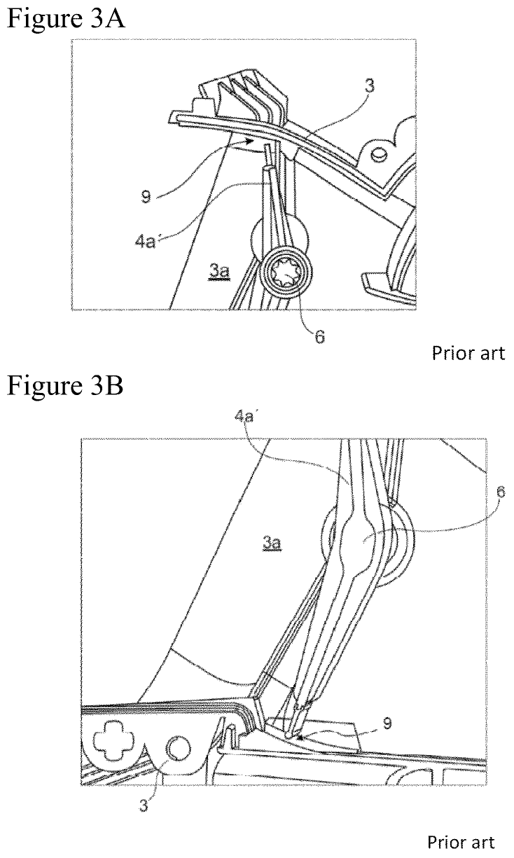

FIGS. 3A and 3B each show a detailed view of the first air guiding device 4a′ of the first air inlet 3a within the air inlet casing 3 of the third air conditioning unit 1-3′ from FIGS. 2A and 2C in an intermediate position for ram pressure compensation.

The ram pressure-dependent closing of the first air inlet 3a by rotating the first air guiding device 4a′ about the axis of rotation 6 leads to very narrow gaps 9 between the first air guiding device 4a′ and the air inlet casing 3 or very narrow flow cross sections of the first air inlet 3a in the form of gaps at high ram pressures and small amounts of fresh air conveyed. The open flow cross section is formed in each case between the front edges of the first air guiding device 4a′ and the wall of the air inlet casing 3. The gaps 9, which have very small dimensions in the radial direction, can be controlled via very small angles of rotation of the first air guiding device 4a about the axis of rotation 6, which can also be supported by suitably designed contours at the air inlet casing 3 in the area of the stops of the air guiding device 4a′.

When the flow cross sections of the first air inlet 3a are only slightly open, ram pressure regulation not possible by a drive with a conventional stepper motor because the movement of the first air guiding device 4a′ is not controlled without play. As a result of the only slightly open flow cross section and the amount of air mass flow flowing through the open flow cross section, disturbing noises such as hissing or whistling can also be emitted.

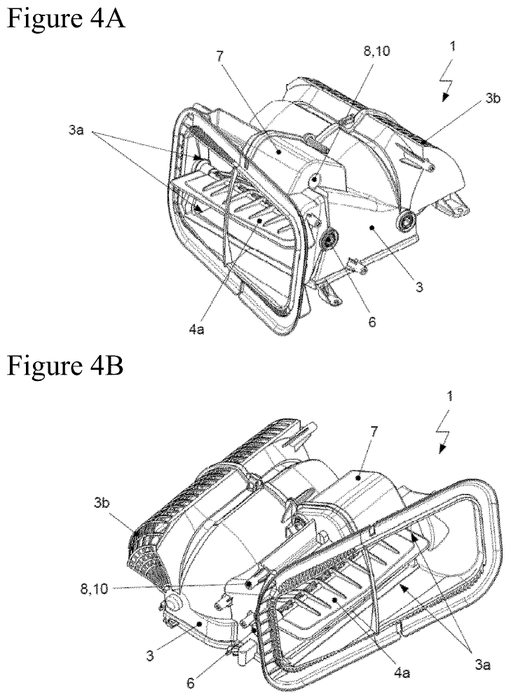

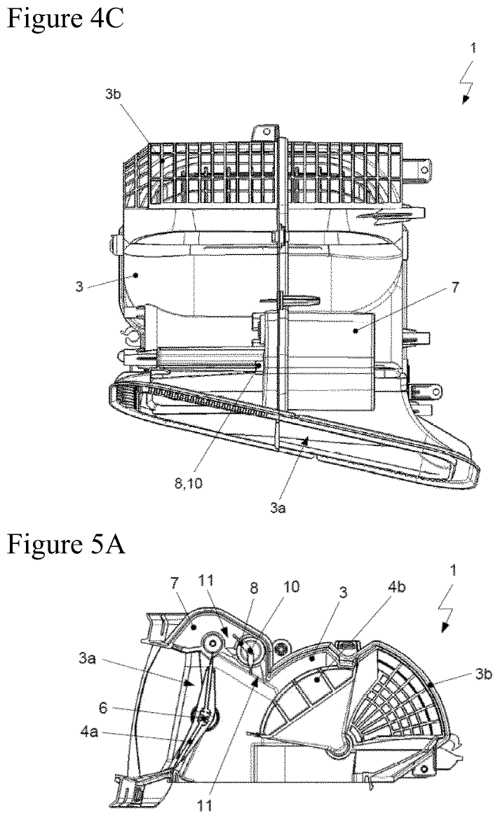

FIGS. 4A to 4C each show a perspective view of the air conditioning unit 1 according to the invention of a motor vehicle with the air inlet casing 3 with two air inlets 3a, 3b and the bypass flow duct 7 to the first air inlet 3a and one air guiding device 4a, 4b for independently varying the flow cross sections of the air inlets 3a, 3b and a ram pressure air guiding device 8 for independently varying the flow cross section of the bypass flow duct 7. Here, in each case, the first air guiding device 4a is arranged in the end position “fully open”.

The ram pressure air guiding device 8 designed as an air flap, also referred to as a ram pressure flap, is designed so as to fully close the bypass flow duct 7. In this case, the bypass flow duct 7 has a significantly smaller flow cross section than the first air inlet 3a.

Since fresh ambient air flows into the air conditioning unit 1 both through the first air inlet 3a and through the bypass flow duct 7, the flow cross sections of the first air inlet 3a and the bypass flow duct 7 together represent a flow cross section for the fresh air. In this case, the ram pressure air guiding device 8 is movable independent of the first air guiding device 41 and thus serves to vary only a proportion of the total flow cross section for the fresh air. The flow cross section of the bypass flow duct 7 that represents a portion of the flow cross section for the fresh air can be varied with the ram pressure air guiding device 8, in particular openable and closable.

The first air guiding device 4a and the ram pressure air guiding device 8 are each designed as centrally mounted rotary flaps and pivotable about an axis of rotation 6, 10 between the two end positions “closed” and “fully open”. The first air guiding device 4a and the ram pressure air guiding device 8 each have different intermediate positions on the travel path between the end positions, which enable different degrees of opening of the air inlet 3a or of the bypass flow duct 7.

The axes of rotation 6, 10 are each arranged in the region of the cross-sectional area to be closed, in particular of the first air inlet 3a or the bypass flow duct 7.

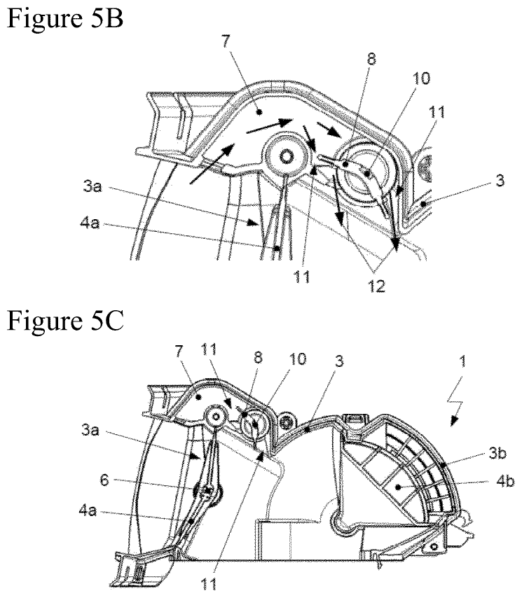

FIG. 5A shows a sectional view of the air conditioning unit 1 according to the invention from FIG. 4A. In this case, the first air inlet 3a is closed and the bypass flow duct 7 for the inflow of fresh air for ram pressure compensation as well as the second air inlet 3b for the inflow of circulating air are each fully opened. The intake air mass flow is consequently composed of a mixture of fresh air and circulating air.

According to FIG. 5B, which shows a detailed representation of the bypass flow duct 7 of the air conditioning unit 1 according to the invention from FIG. 4A, the first air inlet 3a is closed and the bypass flow duct 7 is partially open for ram pressure compensation. In FIG. 5B, the ram pressure air guiding device 8 is aligned in an intermediate position for ram pressure compensation at high ram air pressure, while the ram pressure air guiding device 8 in the arrangement according to FIG. 5A is aligned in the end position “fully open” for ram pressure compensation at a lower ram air pressure.

In this case, the first air guiding device 4a is fixedly arranged in the end position “closed”, while the ram pressure air guiding device 8 arranged within the bypass flow duct 7 is adjustable about the axis of rotation 10 independently of the first air guiding device 4a in order to provide an open gap 11 or a gap-shaped, open flow cross section of the bypass flow duct 7 and thus of the flow cross section for the fresh air between the air inlet casing 3 and the ram pressure air guiding device 8. The fresh air flows in the flow direction 12 between the front edges of the ram pressure air guiding device 8 and the wall of the bypass flow duct 7 of the air inlet casing 3 and thus through the open flow cross section of the bypass flow duct 7.

The front edges of the first air guiding device 4a abut the wall of the air inlet casing 3, closing the flow cross section of the first air inlet 3a. A sealing element is advantageously provided in each case between the first air guiding device 4a and the wall of the air inlet casing 3.

In contrast to the first air guiding device 4a, the ram pressure air guiding device 8 arranged within the bypass flow duct 7 is adjusted about the axis of rotation 10 in such a way that the flow cross section of the bypass flow duct 7 is opened proportionally as required, or an open gap 11 is provided between the air inlet casing 3 and the ram pressure air guiding device 8. The flow cross section for the fresh air is at least partially open in the area of the bypass flow duct 7.

The first air guiding device 4a and ram pressure air guiding device 8, each designed as centrally mounted rotary flaps, can each be connected to a drive element, which is designed as a servomotor, in particular as a linear or continuous servomotor or as a stepper motor.

Alternatively, the first air guiding device 4a and the ram pressure air guiding device 8 can be controlled via a common mechanism or one that is coupled to one another, so that only one actuator, for example a stepper motor, is required to actuate both air guiding devices.

With the separate control of the air guiding device 8 for the control of the first air guiding device 4a and thus the full closing of the first air guiding device 4a as well as the at least partial opening of the ram pressure air guiding device 8, significantly lower flow cross sections for the fresh air can be set than with the first air guiding device 4a alone.

The design of the bypass flow duct 7 with the ram pressure air guiding device 8 enables very fine control of the gap 11 as a flow cross section for the fresh air, since the change in the flow cross section for the fresh air, depending on the angle of rotation of the ram pressure air guiding device 8, is significantly smaller than the change in the flow cross section of the first air inlet 3a depending on the angle of rotation of the first air guiding device 4a. The ram pressure compensation can be controlled very precisely in this way.

In an operating mode with a mixture of circulating air and only a small proportion of fresh air, for example, in the case of fresh air at a very low temperature, only the small amount of fresh air has to be heated, while in the case of fresh air at a very high temperature, only the small amount of fresh air has to be cooled, which leads to significant energy savings in electrically powered motor vehicles in each case and thus affects the range of the motor vehicle, which is significantly increased.

In the closed final state of the ram pressure air guiding device 8, for example according to FIGS. 2B and 2D, the front edges of the ram pressure air guiding device 8 abut the wall of the air inlet casing 3, closing the flow cross section of the bypass flow duct 7. A sealing element is advantageously provided between the wall of the air inlet casing 3 in the area of the bypass flow duct 7 and the ram pressure air guiding device 8.

FIG. 5C shows a sectional view of the air conditioning unit 1 according to the invention from FIG. 4A with an alignment of the air guiding devices 4a, 4b in which the first air inlet 3a is closed and the bypass flow duct 7 is fully open for the inflow of fresh air for ram pressure compensation, and the second air inlet 3b is closed for the inflow of circulating air. Consequently, only fresh air is taken in by the air conditioning unit 1.

Depending on the amount of air needed and the required control accuracy, various embodiments of the bypass flow duct 7 with the ram pressure air guiding device 8 are conceivable. In addition to the bypass flow duct 7 shown in the figures on a first side of the air inlet 3a, the bypass flow duct can also be formed on a second side that differs from the first side or on both sides of the air inlet. In addition, depending on the available installation space, mixed forms with bypass ducts on different sides of the air intake for the fresh air are possible.

1-14. (canceled)

15. An air conditioning unit for a motor vehicle comprising:
a casing with at least one first air inlet for intake of fresh ambient air and a second air inlet for intake of circulating air from a passenger compartment; and
a first air guiding device for varying a flow cross section of the at least one first air inlet and a second air guiding device for varying a flow cross section of the second air inlet, wherein the first air guiding device and the second air guiding device are air flaps arranged movably mounted between two end positions, wherein a bypass flow duct with a ram pressure air guiding device is formed for the at least one first air inlet, wherein the ram pressure air guiding device is arranged as an air flap movably mounted between two end positions and fully closes the bypass flow duct in an end position.

16. The air conditioning unit according to claim 15, wherein the bypass flow duct has a smaller flow cross section than the at least one first air inlet.

17. The air conditioning unit according to claim 15, wherein the ram pressure air guiding device is movable independently of the first air guiding device for varying the flow cross section of the at least one first air inlet.

18. The air conditioning unit according to claim 15, wherein the first air guiding device of the at least one first air inlet and/or the second air guiding device of the second air inlet and/or the ram pressure air guiding device for varying a flow cross section of the bypass flow duct is/are arranged pivotably mounted about an axis of rotation in each case.

19. The air conditioning unit according to claim 18, wherein the ram pressure air guiding device is a centrally mounted rotary flap which is arranged pivotably mounted about the axis of rotation between a first end position “closed” and a second end position “fully open”.

20. The air conditioning unit according to claim 18, wherein the first air guiding device for varying the flow cross section of the at least one first air inlet is a centrally mounted rotary flap which is arranged pivotably mounted about the axis of rotation between a first end position “closed” and a second end position “fully open”.

21. The air conditioning unit according to claim 15, wherein the casing has a fan casing for accommodating a fan, and an air inlet casing with the at least one first air inlet and the second air inlet, as well as the bypass flow duct.

22. The air conditioning unit according to claim 15, wherein the ram pressure air guiding device is continuously alignable on a travel path between the two end positions in intermediate positions for opening a flow cross section of the bypass flow duct with different degrees of opening, wherein the ram pressure air guiding device in a first end position “closed” abuts the casing, in particular an air inlet casing of the casing and seals the bypass flow duct.

23. Air conditioning unit according to claim 18, wherein the second air guiding device for varying the flow cross section of the second air inlet is a rotary flap which is arranged pivotably mounted about the axis of rotation between a first end position “closed” and a second end position “fully open”, wherein the axis of rotation is designed at a distance from a cross-sectional area of the second air inlet to be closed.

24. The air conditioning unit according to claim 15, wherein the first air guiding device and the second air guiding device are continuously alignable on a travel path between the two end positions in intermediate positions for opening the flow cross section of the at least one first air inlet and the second air inlet with different degrees of opening, wherein the first air guiding device and the second air guiding device in a first end position “closed” abut an air inlet casing and seal the at least one first air inlet and the second air inlet.

25. The air conditioning unit according to claim 15, wherein the first air guiding device of the at least one first air inlet and the ram pressure air guiding device are each connected to a drive element or to a common drive element via a drive mechanism.

26. The air conditioning unit according to claim 25, wherein the drive element is a servomotor.

27. An air conditioning system for the motor vehicle with means for conveying, for cooling and for heating air, having the air conditioning unit according to claim 15.

28. A method for operating the air conditioning unit for the motor vehicle according to claim 15, wherein a composition of an air mass flow consisting of pure fresh ambient air, pure circulating air from the passenger compartment or a mixture of fresh air and circulating air sucked into the air conditioning unit is set by adjusting positions of the first air guiding device and the second air guiding device as well as the ram pressure air guiding device for independently varying the flow cross sections of the at least one first air inlet and the second air inlet and a flow cross section of the bypass flow duct, wherein in an operating mode of ram pressure compensation, a mass flow of the fresh air is throttled through the flow cross section of the bypass flow duct, in that the first air guiding device arranged in the flow cross section of the at least one first air inlet of the fresh air is brought into an end position “closed” and the ram pressure air guiding device arranged in the bypass flow duct independently of the first air guiding device of the at least one first air inlet of the fresh air is adjusted in such a way that an open gap is formed between a wall of the casing of the air conditioning unit and the ram pressure air guiding device and the flow cross section of the at least one first air inlet of the fresh ambient air is opened depending on an alignment of the ram pressure air guiding device.
